(19) United States
(12) Patent Application Publication
(10) Pub. No.: US 2019/0156337 A1
(43) Pub. Date: May 23, 2019

(54) System and Method for Processing Deferred Authorization Transactions

(71) Applicant: Visa International Service Association, San Francisco, CA (US)

(72) Inventors: Robert Franklin Alandt, San Mateo, CA (US); Barbara Elizabeth Patterson, South San Francisco, CA (US); Anjana Neera Surin, Foster City, CA (US)

(21) Appl. No.: 15/816,431

(22) Filed: Nov. 17, 2017

(51) Int. Cl. G06Q 20/40

(52) U.S. Cl. CPC G06Q 20/405

(57) ABSTRACT

A method of processing a deferred authorization transaction including: receiving at least one transaction processing request associated with a transaction, where the transaction is initiated using a portable financial device associated with a user, the at least one transaction processing request including a deferred authorization indicator; determining that the at least one transaction processing request includes the deferred authorization indicator; determining that the transaction is a deferred authorization transaction based on determining that the at least one transaction processing request includes the deferred authorization indicator; and processing the transaction using at least one deferred authorization transaction rule in response to determining that the transaction is a deferred authorization transaction. A system for processing a deferred authorization transaction is also disclosed.

### BACKGROUND OF THE INVENTION

### Field of the Invention

The present invention generally relates to deferred authorization transactions and, in some embodiments, to a system and method for processing deferred authorization transactions.

### Description of Related Art

In some scenarios, a merchant system cannot communicate with a transaction processing server of a transaction service provider during a transaction initiated by a portable financial device. For example, airlines regularly conduct transactions with passengers for food, beverages, entertainment, and the like in-flight, while the merchant system is not in communication with the transaction processing server. In other examples, the merchant system or transaction processing server may crash, resulting in a temporary halt in communication between the two systems. Such transactions are considered deferred authorization transactions because a transaction processing request is communicated to the transaction processing server after the goods and/or services and transaction data have been exchanged between the customer and the merchant.

These deferred authorization transactions can cause transaction processing issues for issuer institutions and for merchants. In some cases, the deferred authorization transaction is mistakenly denied because certain information associated with the transaction appears fraudulent. This mistaken transaction processing error delays the ultimate completion of the transaction. For tokenized contactless transactions, there is a possibility that the token can be deleted by either the cardholder or the issuer institution before a merchant can complete the deferred authorization, causing the merchant to receive an authorization decline response. Therefore, there is a need in the art for an improved system and method that allows for deferred authorization transactions to be processed.

### SUMMARY OF THE INVENTION

Accordingly, it is an object of the present invention to provide a system and method for processing deferred authorization transactions that overcomes some or all of the deficiencies of the prior art.

According to a non-limiting embodiment or aspect, provided is a method of processing a deferred authorization transaction including: receiving, with at least one processor, at least one transaction processing request associated with a transaction, the at least one transaction processing request including a deferred authorization indicator, where the transaction is initiated using a portable financial device associated with a user; determining, with at least one processor, that the at least one transaction processing request includes the deferred authorization indicator; determining, with at least one processor, that the transaction is a deferred authorization transaction based on determining that the at least one transaction processing request includes the deferred authorization indicator; and processing, with at least one processor, the transaction using at least one deferred authorization transaction rule in response to determining that the transaction is a deferred authorization transaction.

In a non-limiting embodiment or aspect, the at least one transaction processing request may include transaction data associated with a chip of the portable financial device. The transaction data associated with the chip of the portable financial device may include an application transaction counter. The processing of the deferred authorization transaction may include analyzing the application transaction counter of the at least one transaction processing request and authorizing or denying the deferred authorization transaction associated with the at least one transaction processing request based at least partially on the application transaction counter. The at least one transaction processing request may include a token associated with an account identifier, and the account identifier may be associated with the user. Processing the transaction using the at least one deferred authorization rule may include retrieving the account identifier based on the token; and communicating at least one transaction processing message including the account identifier. The method may further include authorizing the at least one transaction processing request based at least partially on the account identifier; or denying the at least one transaction processing request based at least partially on the account identifier. Processing the transaction using at least one deferred authorization transaction rule may include communicating at least one transaction processing message for further processing of the deferred authorization transaction, where the at least one transaction processing message includes the at least one transaction processing request.

In a non-limiting embodiment or aspect, the method further includes receiving, with at least one processor, transaction data associated with the transaction, the transaction data including the deferred authorization indicator; generating, with at least one processor, the at least one transaction processing request, where the at least one transaction processing request includes the deferred authorization indicator; and communicating, with at least one processor, the at least one transaction processing request. The method may further include receiving, with at least one processor, at least one transaction processing message for further processing of the deferred authorization transaction, where the at least one transaction processing message includes the at least one transaction processing request; determining, with at least one processor, whether to authorize or deny the deferred authorization transaction associated with the at least one transaction processing request based at least partially on the transaction processing message; generating, with at least one processor, a response message including an authorization response based on the determining whether to authorize or deny the deferred authorization transaction; and, in response to receiving the at least one transaction processing message, communicating, with at least one processor, the response message. The at least one transaction processing request may include a first message format, and the method may further include: converting, with at least one processor, the at least one transaction processing request into a second message format, resulting in at least one transaction processing message, based on the first message format, where the second message format corresponds to a message format associated with a network, and the network is associated with a transaction service provider; and communicating the transaction processing message having the second message format. Receiving the at least one transaction processing request may include receiving the at least one transaction processing request in a first message format, where the first message format corresponds to a message format associated with a network, and the network is associated with a transaction service provider.

According to another non-limiting embodiment or aspect, provided is a system for processing a deferred authorization transaction, including at least one server computer including at least one processor, the at least one server computer programmed or configured to: receive at least one transaction processing request associated with a transaction, the at least one transaction processing request including a deferred authorization indicator, where the transaction is initiated using a portable financial device associated with a user; determine that the at least one transaction processing request includes the deferred authorization indicator; determine that the transaction is a deferred authorization transaction based on determining that the at least one transaction processing request includes the deferred authorization indicator; and process the transaction using at least one deferred authorization transaction rule in response to determining that the transaction is a deferred authorization transaction.

In a non-limiting embodiment or aspect, the at least one transaction processing request may include transaction data associated with a chip of the portable financial device. The transaction data associated with the chip of the portable financial device may include an application transaction counter. The at least one server computer may be further programmed or configured to analyze the application transaction counter of the at least one transaction processing request and authorize or deny the deferred authorization transaction associated with the at least one transaction processing request based at least partially on the application transaction counter. The at least one transaction processing request may include a token associated with an account identifier, where the account identifier is associated with the user. The at least one server computer may be further programmed or configured to retrieve the account identifier based on the token; and communicate at least one transaction processing message including the account identifier. The at least one server computer may be further programmed or configured to authorize the at least one transaction processing request based at least partially on the account identifier; or deny the at least one transaction processing request based at least partially on the account identifier. The at least one server computer may be further programmed or configured to communicate at least one transaction processing message for further processing of the deferred authorization transaction, where the at least one transaction processing message includes the at least one transaction processing request.

In a non-limiting embodiment or aspect, the at least one server computer may be further programmed or configured to: receive transaction data associated with the transaction, the transaction data including the deferred authorization indicator; generate the at least one transaction processing request, where the at least one transaction processing request includes the deferred authorization indicator; and communicate the at least one transaction processing request. The at least one server computer may be further programmed or configured to: receive at least one transaction processing message for further processing of the deferred authorization transaction, where the at least one transaction processing message includes the at least one transaction processing request; determine whether to authorize or deny the deferred authorization transaction associated with the at least one transaction processing request based at least partially on the transaction processing message; generate a response message including an authorization response based on the determining whether to authorize or deny the deferred authorization transaction; and, in response to receiving the at least one transaction processing message, communicate the response message. The transaction processing message may include a first message format, and wherein the at least one server computer is further programmed or configured to: convert the at least one transaction processing request into a second message format, resulting in at least one transaction processing message, based on the first message format, where the second message format corresponds to a message format associated with a network, and the network is associated with a transaction service provider; and communicate the at least one transaction processing message having the second message format. The at least one server computer may be further programmed or configured to: receive the at least one transaction processing request in a first message format, where the first message format corresponds to a message format associated with a network, and the network is associated with a transaction service provider.

Further embodiments or aspects are set forth in the following numbered clauses:

Clause 1: A method of processing a deferred authorization transaction comprising: receiving, with at least one processor, at least one transaction processing request associated with a transaction, wherein the transaction is initiated using a portable financial device associated with a user, the at least one transaction processing request comprising a deferred authorization indicator; determining, with at least one processor, that the at least one transaction processing request comprises the deferred authorization indicator; determining, with at least one processor, that the transaction is a deferred authorization transaction based on determining that the at least one transaction processing request comprises the deferred authorization indicator; and processing, with at least one processor, the transaction using at least one deferred authorization transaction rule in response to determining that the transaction is a deferred authorization transaction.

Clause 2: The method of clause 1, wherein the at least one transaction processing request comprises transaction data associated with a chip of the portable financial device.

Clause 3: The method of clause 1 or 2, wherein the transaction data associated with the chip of the portable financial device comprises an application transaction counter.

Clause 4: The method of any of the preceding clauses, wherein the processing of the deferred authorization transaction comprises analyzing the application transaction counter of the at least one transaction processing request and authorizing or denying the deferred authorization transaction associated with the at least one transaction processing request based at least partially on the application transaction counter.

Clause 5: The method of any of the preceding clauses, wherein the at least one transaction processing request comprises a token associated with an account identifier, wherein the account identifier is associated with the user.

Clause 6: The method of any of the preceding clauses, wherein processing the transaction using the at least one deferred authorization rule comprises: retrieving the account identifier based on the token; and communicating at least one transaction processing message comprising the account identifier.

Clause 7: The method of any of the preceding clauses, further comprising: authorizing the at least one transaction processing request based at least partially on the account identifier; or denying the at least one transaction processing request based at least partially on the account identifier.

Clause 8: The method of any of the preceding clauses, wherein processing the transaction using at least one deferred authorization transaction rule comprises: communicating at least one transaction processing message for further processing of the deferred authorization transaction, wherein the at least one transaction processing message comprises the at least one transaction processing request.

Clause 9: The method of any of the preceding clauses, further comprising: receiving, with at least one processor, transaction data associated with the transaction, the transaction data including the deferred authorization indicator; generating, with at least one processor, the at least one transaction processing request, wherein the at least one transaction processing request comprises the deferred authorization indicator; and communicating, with at least one processor, the at least one transaction processing request.

Clause 10: The method of any of the preceding clauses, further comprising: receiving, with at least one processor, at least one transaction processing message for further processing of the deferred authorization transaction, wherein the at least one transaction processing message comprises the at least one transaction processing request; determining, with at least one processor, whether to authorize or deny the deferred authorization transaction associated with the at least one transaction processing request based at least partially on the transaction processing message; generating, with at least one processor, a response message comprising an authorization response based on the determining whether to authorize or deny the deferred authorization transaction; and, in response to receiving the at least one transaction processing message, communicating, with at least one processor, the response message.

Clause 11: The method of claim 1, wherein the at least one transaction processing request comprises a first message format, the method further comprising: converting, with at least one processor, the at least one transaction processing request into a second message format, resulting in at least one transaction processing message, based on the first message format, wherein the second message format corresponds to a message format associated with a network, wherein the network is associated with a transaction service provider; and communicating the transaction processing message having the second message format.

Clause 12: The method of any of the preceding clauses, wherein receiving the at least one transaction processing request comprises receiving the at least one transaction processing request in a first message format, wherein the first message format corresponds to a message format associated with a network, wherein the network is associated with a transaction service provider.

Clause 13: A system for processing a deferred authorization transaction, comprising at least one server computer including at least one processor, the at least one server computer programmed or configured to: receive at least one transaction processing request associated with a transaction, wherein the transaction is initiated using a portable financial device associated with a user, the at least one transaction processing request comprising a deferred authorization indicator; determine that the at least one transaction processing request comprises the deferred authorization indicator; determine that the transaction is a deferred authorization transaction based on determining that the at least one transaction processing request comprises the deferred authorization indicator; and process the transaction using at least one deferred authorization transaction rule in response to determining that the transaction is a deferred authorization transaction.

Clause 14: The system of clause 13, wherein the at least one transaction processing request comprises transaction data associated with a chip of the portable financial device.

Clause 15: The system of clause 13 or 14, wherein the transaction data associated with the chip of the portable financial device comprises an application transaction counter.

Clause 16: The system of any of clauses 13-15, wherein the at least one server computer is further programmed or configured to analyze the application transaction counter of the at least one transaction processing request and authorize or deny the deferred authorization transaction associated with the at least one transaction processing request based at least partially on the application transaction counter.

Clause 17: The system of any of clauses 13-16, wherein the at least one transaction processing request comprises a token associated with an account identifier, wherein the account identifier is associated with the user.

Clause 18: The system of any of clauses 13-17, wherein the at least one server computer is further programmed or configured to retrieve the account identifier based on the token; and communicate at least one transaction processing message comprising the account identifier.

Clause 19: The system of any of clauses 13-18, wherein the at least one server computer is further programmed or configured to authorize the at least one transaction processing request based at least partially on the account identifier; or deny the at least one transaction processing request based at least partially on the account identifier.

Clause 20: The system of any of clauses 13-19, wherein the at least one server computer is further programmed or configured to communicate at least one transaction processing message for further processing of the deferred authorization transaction, wherein the at least one transaction processing message comprises the at least one transaction processing request.

Clause 21: The system of any of clauses 13-20, wherein the at least one server computer is further programmed or configured to: receive transaction data associated with the transaction, the transaction data including the deferred authorization indicator; generate the at least one transaction processing request, wherein the at least one transaction processing request comprises the deferred authorization indicator; and communicate the at least one transaction processing request.

Clause 22: The system of any of clauses 13-21, wherein the at least one server computer is further programmed or configured to: receive at least one transaction processing message for further processing of the deferred authorization transaction, wherein the at least one transaction processing message comprises the at least one transaction processing request; determine whether to authorize or deny the deferred authorization transaction associated with the at least one transaction processing request based at least partially on the transaction processing message; generate a response message comprising an authorization response based on the determining whether to authorize or deny the deferred authorization transaction; and in response to receiving the at least one transaction processing message, communicate the response message.

Clause 23: The system of claim 13, wherein the transaction processing message comprises a first message format, and wherein the at least one server computer is further programmed or configured to: convert the at least one transaction processing request into a second message format, resulting in at least one transaction processing message, based on the first message format, wherein the second message format corresponds to a message format associated with a network, wherein the network is associated with a transaction service provider; and communicate the at least one transaction processing message having the second message format.

Clause 24: The system of any of clauses 13-23, wherein the at least one server computer is further programmed or configured to: receive the at least one transaction processing request in a first message format, wherein the first message format corresponds to a message format associated with a network, wherein the network is associated with a transaction service provider.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

Additional advantages and details of the invention are explained in greater detail below with reference to the exemplary embodiments that are illustrated in the accompanying schematic figures, in which:

FIG. 1 is a schematic view of a non-limiting embodiment or aspect of a system for processing transactions in which the merchant system cannot communicate with the transaction processing server;

FIG. 2 is a non-limiting embodiment or aspect of deferred authorization transactions collected by the merchant system and including a deferred authorization indicator;

FIG. 3 is a schematic view of a non-limiting embodiment or aspect of a system for processing transactions in which the merchant system communicates with the transaction processing server following a disruption in connection between the two systems;

FIG. 4 is a schematic view of a non-limiting embodiment or aspect of a system for processing of a deferred authorization transaction;

FIG. 5 is a step diagram of a non-limiting embodiment or aspect of a method of processing deferred authorization transactions; and

FIG. 6 is a process flow diagram of a non-limiting embodiment or aspect of a method of processing deferred authorization transactions.

### DESCRIPTION OF THE INVENTION

For purposes of the description hereinafter, the terms “end”, “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

As used herein, the terms “communication” and “communicate” may refer to the reception, receipt, transmission, transfer, provision, and/or the like, of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments, a message may refer to a network packet (e.g., a data packet, and/or the like) that includes data. It will be appreciated that numerous other arrangements are possible.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments, may be operated by or on behalf of a transaction service provider.

As used herein, the term “issuer institution” or “issuer” may refer to one or more entities, such as a bank, that provide accounts to customers for conducting transactions (e.g., payment transactions), such as initiating credit and/or debit payments. For example, an issuer institution may provide an account identifier, such as a personal account number (PAN), to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer systems operated by or on behalf of an issuer institution, such as a server computer executing one or more software applications. For example, an issuer system may include one or more authorization servers for authorizing a transaction.

As used herein, the term “acquirer institution” or “acquirer” may refer to an entity licensed and/or approved by the transaction service provider to originate transactions (e.g., payment transactions) using a portable financial device associated with the transaction service provider. The transactions the acquirer institution may originate may include payment transactions (e.g., purchases, original credit transactions (OCTs), account funding transactions (AFTs), and/or the like). In some non-limiting embodiments, an acquirer institution may be a financial institution, such as a bank. As used herein, the term “acquirer system” may refer to one or more computer systems, computer devices, software applications, and/or the like operated by or on behalf of an acquirer institution.

As used herein, the term “account identifier” may include one or more PANs, tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications. A “point-of-sale (POS) system,” as used herein, may refer to one or more computers and/or peripheral devices used by a merchant to engage in payment transactions with customers, including one or more card readers, near-field communication (NFC) receivers, RFID receivers, and/or other contactless transceivers or receivers, contact-based receivers, payment terminals, computers, servers, input devices, and/or other like devices that can be used to initiate a payment transaction.

As used herein, the term “mobile device” may refer to one or more portable electronic devices configured to communicate with one or more networks. As an example, a mobile device may include a cellular phone (e.g., a smartphone or standard cellular phone), a portable computer (e.g., a tablet computer, a laptop computer, etc.), a wearable device (e.g., a watch, pair of glasses, lens, clothing, and/or the like), a personal digital assistant (PDA), and/or other like devices. The term “client device,” as used herein, refers to any electronic device that is configured to communicate with one or more servers or remote devices and/or systems. A client device may include a mobile device, a network-enabled appliance (e.g., a network-enabled television, refrigerator, thermostat, and/or the like), a computer, a POS system, and/or any other device or system capable of communicating with a network.

As used herein, the term “computing device” may refer to one or more electronic devices that are configured to directly or indirectly communicate with or over one or more networks. The computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. The computing device may not be a mobile device, such as a desktop computer. Furthermore, the term “computer” may refer to any computing device that includes the necessary components to receive, process, and output data, and normally includes a display, a processor, a memory, an input device, and a network interface. An “application” or “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, etc.).

As used herein, the term “portable financial device” may refer to a portable payment card (e.g., a credit or debit card), a gift card, a smartcard, smart media, a payroll card, a healthcare card, a wrist band, a machine-readable medium containing account information, a keychain device or fob, an RFID transponder, a retailer discount or loyalty card, a mobile device executing an electronic wallet application, a personal digital assistant, a security card, an access card, a wireless terminal, and/or a transponder, as examples. The financial device may include a volatile or a non-volatile memory to store information, such as an account identifier or a name of the account holder. The financial device may store account credentials locally on the device, in digital or non-digital representation, or may facilitate accessing account credentials stored in a medium that is accessible by the financial device in a connected network.

The term “account data,” as used herein, refers to any data concerning one or more accounts for one or more users. Account data may include, for example, one or more account identifiers, user identifiers, transaction histories, balances, credit limits, issuer institution identifiers, and/or the like.

As used herein, the term “server” may refer to or include one or more processors or computers, storage devices, or similar computer arrangements that are operated by or facilitate communication and processing for multiple parties in a network environment, such as the internet, although it will be appreciated that communication may be facilitated over one or more public or private network environments and that various other arrangements are possible. Further, multiple computers, e.g., servers, or other computerized devices, e.g., point-of-sale devices, directly or indirectly communicating in the network environment may constitute a “system,” such as a merchant's point-of-sale system. Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

Non-limiting embodiments or aspects of the present invention are directed to a system and method for processing deferred authorization transactions. Non-limiting embodiments or aspects of the method and system allow issuers to process deferred authorization transactions more successfully, with fewer denials of non-fraudulent deferred authorization transactions. Non-limiting embodiments of the system and method use a non-conventional transaction message, modified from traditional transaction messages, to indicate that the transaction is a deferred authorization transaction. The non-conventional, unique transaction message includes a deferred authorization indicator, and this indicator alerts issuers (and/or the acquirer or the transaction service provider), that the transaction is a deferred authorization transaction requiring processing using a separate set of processing rules. Non-limiting embodiments or aspects of the system and method allow for an automatic determination that the transaction is a deferred authorization transaction. The automatic determination that the transaction is a deferred authorization transaction allows the acquirer, transaction service provider, and/or issuer system to perform automatic actions in response thereto, so that the deferred authorization transaction is processed according to the correct protocol and so that processing delays can be avoided. Non-limiting embodiments or aspects of the system and method allow for more streamlined and efficient processing of transactions, including deferred authorization transactions.

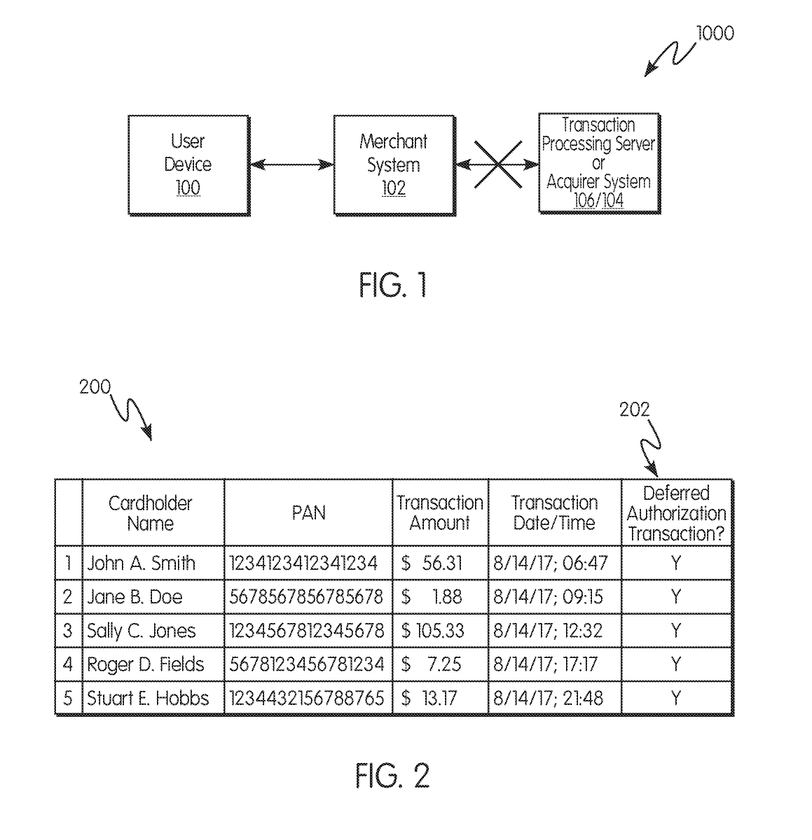

Referring to FIG. 1, a non-limiting embodiment or aspect of a system 1000 for processing transactions is shown. A user device 100 may communicate with a merchant system 102 (such as a merchant point-of-sale system) to initiate a transaction. The user device 100 may be a portable financial device (e.g., credit or debit card), a mobile device (e.g., a smart phone with an electronic wallet application), a computing device, or any other device capable of initiating a transaction between a customer (e.g., user) associated with the user device 100 and a merchant associated with the merchant system 102. The user device 100 may communicate account data to the merchant system 102 in order to initiate the transaction (transaction data). The user device 100 may communicate any other relevant data to the merchant system 102 in order to initiate the transaction (also transaction data). The merchant system 102 may generate other data associated with the transaction (also transaction data).

In the non-limiting embodiment or aspect of the system 1000 shown in FIG. 1, the merchant system 102 may not be able to communicate with a transaction processing server 106 associated with a transaction service provider and/or an acquirer system 104 associated with an acquirer. In some non-limiting embodiments, the merchant system 102 is configured to communicate directly to the transaction processing server 106 without communication via an acquirer system 104. The merchant system 102 may normally communicate with the transaction processing server 106 using a wired or wireless communication. The communication between the merchant system 102 and the transaction processing server 106 may be interrupted, as shown in FIG. 1, for any number of reasons. For example, the merchant system 102 and/or the transaction processing server 106 may have crashed or have gone offline for some other reason, such that the merchant system 102 and the transaction processing server 106 cannot communicate with one another. In one specific example, the merchant system 102 may be associated with a merchant on an airplane or cruise ship that, at least for a period of time, is unable to communicate with the transaction processing server 106, such as while in the air or sailing at a remote location in the ocean.

Referring to FIGS. 1 and 2, although the merchant system 102 may not be able to communicate with the transaction processing server 106, the user device 100 may still initiate transactions with the merchant system 102. FIG. 2 shows deferred authorization transactions 200 collected by the merchant system 102 while the merchant system 102 is unable to communicate with the transaction processing server 106. The deferred authorization transactions 200 may be arranged in a database or any other type of data structure. In this non-limiting embodiment or aspect, the user device 100 may initiate a transaction with the merchant system 102, and the goods and/or services associated with the transaction may be exchanged, such that the transaction is a “partially-completed transaction”. However, the transaction may not be a fully completed transaction until the merchant system 102 communicates a transaction processing request to the transaction processing server 106 and the transaction processing request is successfully processed to completion.

Referring to FIGS. 1 and 2, the merchant system 102 may collect deferred authorization transactions 200, such as the five deferred authorization transactions 200 shown in FIG. 2. The deferred authorization transactions 200 may include account data and any other data required to process the transaction (transaction data) once the merchant system 102 is again able to communicate with the transaction processing server 106. The deferred authorization transactions 200 may include the information shown in FIG. 2, such as cardholder identifiers, personal account number (PAN), transaction amount, and/or transaction date/time. The deferred authorization transaction 200 may also include information not shown in FIG. 2, such as cardholder address and other personal or contact information of the cardholder, bank account number, merchant identifier, merchant address, merchant location, merchant category codes, transaction location, products and/or services purchased identifiers, and the like. The data collected and/or generated (transaction data) by the merchant system 102 for the deferred authorization transactions 200 may be later included in the generated transaction processing request to the transaction processing server 106.

With continued reference to FIGS. 1 and 2, the deferred authorization transaction 200 may include a deferred authorization indicator 202 (also transaction data). In some non-limiting embodiment or aspects, the deferred authorization indicator 202 may be a separate field of the transaction processing request that indicates that the transaction is a deferred authorization transaction 200 initiated while the merchant system 102 was not in communication with the transaction processing server 106. In other non-limiting embodiments, the deferred authorization indicator 202 may be inserted into a pre-existing field of the transaction processing request. As shown in FIG. 2, transactions 1-5 collected by the merchant system 102 are deferred authorization transactions 200 because the merchant system 102 associated the deferred authorization indicator 202 with the transactions. The deferred authorization indicator 202 may be a binary value (e.g., true or false), a flag, a string, an integer, a filled or unfilled field, or any other data type.

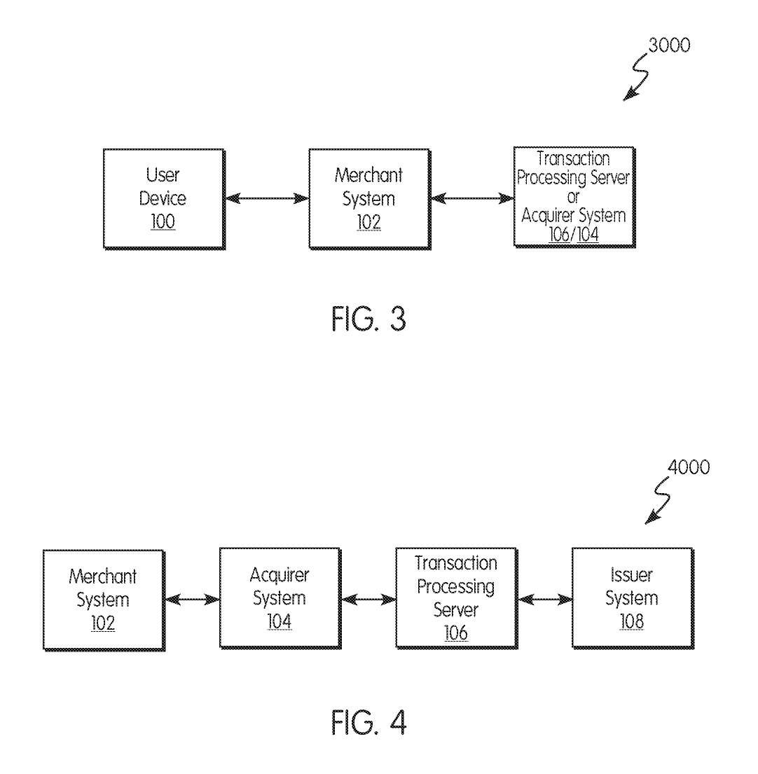

Referring to FIG. 3, a non-limiting embodiment or aspect of a system 3000 for processing transactions is shown with the merchant system 102 now in communication with the transaction processing server 106 following a period of time during which the merchant system 102 was offline as shown in FIGS. 1 and 2. In the system 3000 shown in FIG. 3, the merchant system 102 may communicate transaction processing requests to the transaction processing server 106. The merchant system 102 may communicate transaction processing requests associated with transactions initiated after the merchant system 102 and the transaction processing server 106 are again in communication, which are not deferred authorization transactions 200. The merchant system 102 may also communicate the deferred authorization transactions 200 that were previously initiated (such as in FIGS. 1 and 2). The merchant system 102 may communicate the deferred authorization transactions 200 in a single transaction processing request (e.g., batch request), or the merchant system 102 may communicate each deferred authorization transaction 200 in a separate transaction processing request. The transaction processing requests associated with the deferred authorization transactions 200 may include the deferred authorization indicator 202 to show that the transaction associated with the transaction processing request is a deferred authorization transaction 200. The deferred authorization indicator 202 may be a separate, independent field of the transaction processing request, as opposed to traditional transaction processing requests which do not include any deferred authorization indicator 202 or separate field for the deferred authorization indicator 202.

The transaction processing request may include (in addition to the deferred authorization indicator 202) the other previously-described transaction data. The transaction processing request may include further transaction data, such as transaction data associated with a chip of the portable financial device used to initiate the transaction in the case of a portable financial device using chip card technology. In this example, the further transaction data may include at least one application transaction counter, which may be an ordered count of transactions initiated by the portable financial device. In one example, each transaction initiated by the portable financial device using chip card technology may be assigned a sequential number, such that the first transaction is assigned “1”, the second transaction is assigned “2”, and so forth. In this example, the portable financial device tracks the order in which the transactions were initiated using the application transaction counter. It will be appreciated that the portable financial device may sequentially order the transactions initiated and store such information as further transaction data in any suitable format.

The further transaction data may include transaction data associated with a contactless, tokenized portable financial device. In this example, the further transaction data may include a token associated with an account identifier (e.g., PAN) associated with the user (e.g., cardholder).

Referring to FIG. 4, a system 4000 for processing of a deferred authorization transaction 200 is shown according to a non-limiting embodiment or aspect. The merchant system 102 may communicate with the acquirer system 104 by communicating a transaction processing request associated with a deferred authorization transaction 200 to the acquirer system 104, and the transaction processing request may include the deferred authorization indicator 202. In some examples, the acquirer system 104 may be the same as the transaction processing server 106, such as when the transaction service provider also functions as the acquirer of the merchant. The acquirer system 104 may further process the transaction processing request including the deferred authorization indicator 202. Further processing may include reformatting the transaction processing request into a format accepted by the transaction processing server 106. The acquirer system 104 may communicate the transaction processing request including the deferred authorization indicator 202 (or reformatted transaction processing request) to the transaction processing server 106.

With continued reference to FIG. 4, the transaction processing server 106 may communicate with an issuer system 108 to transmit a transaction processing message including the received transaction processing request. The transaction processing message may include any parameter of the previously-described transaction data, such as the deferred authorization indicator 202. Upon receipt of the transaction processing request, the transaction processing server 106 may analyze the transaction processing request to determine that the transaction processing request includes the deferred authorization indicator 202. The transaction processing server 106 may determine that the transaction associated with the transaction processing request is a deferred authorization transaction 200 based on determining that the transaction processing request includes the deferred authorization indicator 202.

With continued reference to FIG. 4, the transaction processing server 106 may process the transaction before communicating the transaction processing message to the issuer system 108. The transaction processing server 106 may process the transaction processing request using at least one deferred authorization transaction rule based in response to determining that the transaction is a deferred authorization transaction 200. In a non-limiting example, the transaction processing server 106 processing the transaction processing request includes communicating the transaction processing request as a transaction processing message to the issuer system 108 for further processing by the issuer system 108.

With continued reference to FIG. 4, the transaction processing server 106 (or acquirer system 104) may receive the transaction processing request in a first message format corresponding to a message format associated with a network used by a transaction processing server 106. The transaction processing server 106 may communicate the transaction processing message to the issuer system 108 in the first message format. In another non-limiting embodiment or aspect, the first message format may not be in a format associated with the transaction service provider. In this example, the transaction processing server 106 (or acquirer system 104) may convert the at least one processing request into a second message format associated with the transaction service provider. The transaction processing server 106 may communicate the transaction processing message to the issuer system 108 in the second message format.

With continued reference to FIG. 4, processing the transaction by the transaction processing server 106 may include retrieving an account identifier (e.g., PAN) based on a token included in the transaction processing request. This may be performed by the transaction processing server 106 in the case of the portable financial device using tokenized technology, such as contactless tokenized technology. The transaction processing request may not include the PAN of the cardholder, but may instead include a token associated with the PAN or other account identifier. The token may have been previously assigned by the transaction processing server 106 (or acquirer system 104). Based on the token, the transaction processing server 106 may retrieve the account identifier. The transaction processing server 106 may communicate the transaction processing message to the issuer system 108 including the account identifier instead of the token.

With continued reference to FIG. 4, in the case of the portable financial device utilizing chip card technology, the transaction processing server 106 may include the previously-described application transaction counter in the transaction processing message to the issuer system 108.

With continued reference to FIG. 4, in response to receiving the transaction processing message including the deferred authorization indicator 202 from the transaction processing server 106, the issuer system 108 may further process the transaction. The issuer system 108 may further process the deferred authorization transaction 200 according to at least one deferred authorization transaction protocol. This may include analyzing and/or processing the deferred authorization transaction 200 differently from other transactions to avoid denying a non-fraudulent deferred authorization transaction 200.

With continued reference to FIG. 4, upon receiving the transaction processing message, the issuer system 108 may determine whether to authorize or deny the deferred authorization transaction 200 associated with transaction processing message based at least partially on that transaction processing message. The issuer system 108 may generate a response message including an authorization response (authorize or deny) upon determining whether to authorize or deny the deferred authorization transaction 200. The issuer system 108 may communicate the authorization response to the transaction processing server 106, which may ultimately communicate the authorization response to the merchant system 102 and/or the user device 100 to complete processing of the deferred authorization transaction 200.

The issuer system 108 may follow any deferred authorization protocol to avoid denying a non-fraudulent deferred authorization transaction 200. In one example in which the deferred authorization transaction 200 is initiated by a portable financial device including chip card technology, the deferred authorization transaction protocol may include analyzing the application transaction counter of the at least one transaction processing message. The transaction processing message may be authorized or denied based at least partially on the analysis of the application transaction counter. It will be appreciated that in some non-limiting embodiments or aspects, the transaction processing server 106 or the acquirer system 104 may analyze the application transaction counter of the at least one transaction processing request (instead of, or in addition to, the issuer system 108) and communicate the transaction authorization message including the analysis of the application transaction counter to request authorization or denial of the deferred authorization transaction 200 based on the analysis of the application transaction counter. It is contemplated in this disclosure that the transaction processing server 106 may authorize or deny the transaction by communicating the transaction processing message, which requests an authorization or denial of the transaction from the issuer system 108.

In one example, the deferred authorization transaction protocol may include authorizing or denying the transaction based on the account identifier communicated in the transaction processing message by the transaction processing server 106, which was included in lieu of the token received by the transaction processing server 106 in the transaction processing request. It will be appreciated that in some non-limiting embodiments or aspects, the transaction processing server 106 may communicate the transaction authorization message including the account identifier retrieved by the transaction processing server 106 based on the token to request authorization or denial of the deferred authorization transaction 200. In some non-limiting embodiments or aspects, the acquirer system 104 may retrieve the account identifier associated with the token instead of the transaction processing server 106.

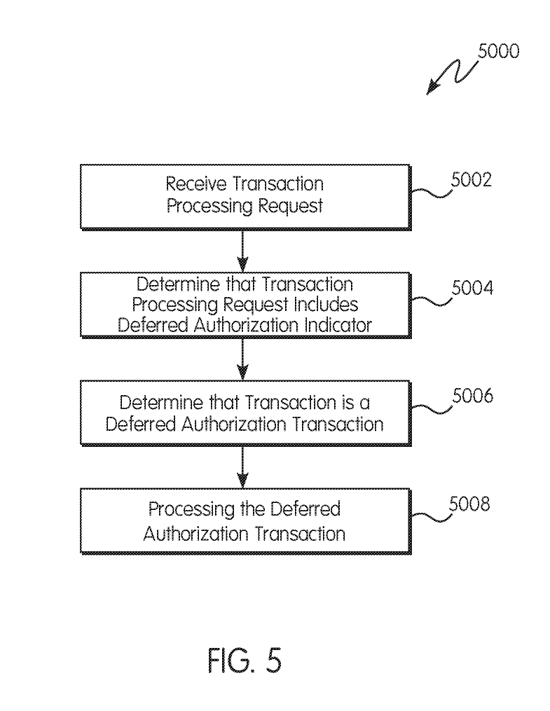

Referring to FIG. 5, a non-limiting embodiment or aspect of a method 5000 of processing deferred authorization transactions 200 is shown. At a step 5002, the transaction processing server 106 may receive at least one transaction processing request associated with the transaction initiated using the portable financial device associated with the user. The transaction processing request may include the deferred authorization indicator 202 signifying that the transaction is a deferred authorization transaction 200. At a step 5004, the transaction processing server 106 may determine that the transaction processing request includes the deferred authorization indicator 202. At a step 5006, the transaction processing server 106 may determine that the transaction is a deferred authorization transaction 200 based on determining that the transaction processing request includes the deferred authorization indicator 202. At a step 5008, the transaction processing server 106 may process the transaction using the at least one deferred authorization transaction rule in response to determining that the transaction is a deferred authorization transaction 200. The transaction processing server 106 may process the deferred authorization transaction 200 using the deferred authorization transaction rule as previously described.

### EXAMPLE

The following example is provided to illustrate an embodiment of the system and method for processing deferred authorization transactions and is not meant to be limiting.

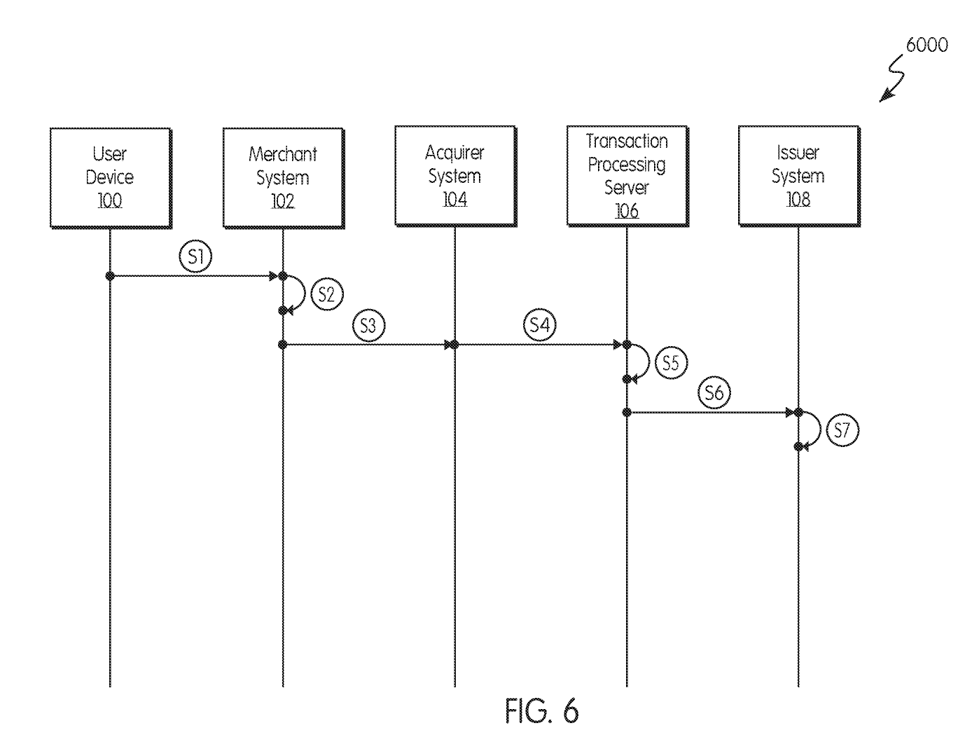

Referring to FIG. 6, a non-limiting example a method 6000 of processing deferred authorization transactions is shown. In this Example, a customer (e.g., Jane Smith) is a passenger on Airliner A's (a merchant) commercial jet flying from Pittsburgh to San Francisco. As the flight is in the air, Jane uses her user device 100 (a portable financial device) to initiate a transaction with Airliner A's merchant system 102 to purchase a meal, beverage, and an in-flight movie. Therefore, at a first step (s1), the user device 100 communicates with the merchant system 102 (merchant POS system) to initiate the deferred authorization transaction 200. Jane initiates the transaction using her user device 100 with the merchant system 102 while the merchant system 102 is unable to communicate with the acquirer system 104 of First Acquirer (the acquirer of Airliner A) (see e.g., FIG. 1). Nonetheless, Jane receives her goods and/or services during the flight and before the merchant system 102 communicates with the acquirer system 104 (a “partially-completed transaction”). At a second step (s2), the merchant system 102 retains the transaction data regarding the deferred authorization transaction 200 and includes a deferred authorization indicator 202 (see e.g., FIG. 2)

After the airplane has landed and Jane has left the airplane, the merchant system 102 is reconnected with the acquirer system 104. At a step 3 (s3), the merchant system 102 communicates a transaction processing request with the transaction data associated with the transaction between Jane and Airliner A (the user device 100 and the merchant system 102). The transaction processing request also includes a deferred authorization indicator 202 that indicates that the transaction is a deferred authorization transaction 200. At a fourth step (s4), the acquirer system 104 communicates the transaction processing request including the deferred authorization indicator 202 to a transaction processing server 106 of First Transaction Service Provider (the transaction service provider of the portable financial device used by Jane to initiate the transaction).

At a fifth step (s5), the transaction processing server 106 receives the transaction processing request and determines that it includes the deferred authorization indicator 202. Further, the transaction processing server 106 determines that the transaction is a deferred authorization transaction 200 based on it determining that the transaction processing request includes the deferred authorization indicator 202.

At the fifth step (s5), the transaction processing server 106 processes the deferred authorization transaction 200 using deferred authorization transaction rules in response to determining that the transaction is a deferred authorization transaction 200. Further, in the case of the portable financial device using token-based technology, the transaction processing server 106 replaces the token with the account identifier associated with the portable financial device (e.g., PAN number). Further, in the case of the portable financial device using chip car technology, the transaction processing server 106 includes the application transaction counter as transaction data.

At a sixth step (s6) (which is still part of processing by the transaction processing server 106), the transaction processing server 106 communicates a transaction processing message to an issuer system 108 of First Issuer Bank (the issuer issuing the portable financial device to Jane). The transaction processing message includes the transaction processing request. The transaction processing message requests an authorization or denial of the transaction by the issuer system 108. The transaction processing message includes the account identifier instead of the token, if applicable. The transaction processing message includes the application transaction counter, if applicable.

At a seventh step (s7), the issuer system 108, upon receiving the transaction processing message, automatically determines whether the deferred authorization transaction 200 is to be authorized or denied based at least partially on the deferred authorization indicator 202. In the case of the portable financial device using token-based technology, the issuer system 108 bases its authorization response partially on the account identifier replaced by the token. In the case of the portable financial device using chip card technology, the issuer system 108 analyzes the application transaction counter and bases its authorization response at least partially on the analysis of the application transaction counter (alternatively, the transaction processing server 106 may analyze the application transaction counter). It will be appreciated that the issuer system 108 may base its authorization response on any information it deems relevant from the transaction processing message. The issuer system 108 communicates the authorization response to the transaction processing server 106 to further process and complete the deferred authorization transaction 200. Upon completion of the transaction, Jane's portable financial device account is charged for the goods and/or services purchased and Airliner A receives the amount of the purchase (less relevant taxes, fees, and the like). The issuer system 108 (and also the transaction processing server 106 and the acquirer system 104) handles the deferred authorization transaction 200 between Jane and Airliner A using a separate protocol application to deferred authorization transactions 200 in order to successfully processes the deferred authorization transaction 200 and avoid a denial of a non-fraudulent transaction.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A method of processing a deferred authorization transaction, comprising:
receiving, with at least one processor, at least one transaction processing request associated with a transaction, the at least one transaction processing request comprising a deferred authorization indicator, wherein the transaction is initiated using a portable financial device associated with a user;
determining, with at least one processor, that the at least one transaction processing request comprises the deferred authorization indicator;
determining, with at least one processor, that the transaction is a deferred authorization transaction based on determining that the at least one transaction processing request comprises the deferred authorization indicator; and
processing, with at least one processor, the transaction using at least one deferred authorization transaction rule in response to determining that the transaction is a deferred authorization transaction.

2. The method of claim 1, wherein the at least one transaction processing request comprises transaction data associated with a chip of the portable financial device.

3. The method of claim 2, wherein the transaction data associated with the chip of the portable financial device comprises an application transaction counter.

4. The method of claim 3, wherein the processing of the deferred authorization transaction comprises analyzing the application transaction counter of the at least one transaction processing request and authorizing or denying the deferred authorization transaction associated with the at least one transaction processing request based at least partially on the application transaction counter.

5. The method of claim 1, wherein the at least one transaction processing request comprises a token associated with an account identifier, wherein the account identifier is associated with the user.

6. The method of claim 5, wherein processing the transaction using the at least one deferred authorization rule comprises:
retrieving the account identifier based on the token; and
communicating at least one transaction processing message comprising the account identifier.

7. The method of claim 6, further comprising:
authorizing the at least one transaction processing request based at least partially on the account identifier; or
denying the at least one transaction processing request based at least partially on the account identifier.

8. The method of claim 1, wherein processing the transaction using at least one deferred authorization transaction rule comprises:
communicating at least one transaction processing message for further processing of the deferred authorization transaction, wherein the at least one transaction processing message comprises the at least one transaction processing request.

9. The method of claim 1, further comprising:
receiving, with at least one processor, transaction data associated with the transaction, the transaction data including the deferred authorization indicator;
generating, with at least one processor, the at least one transaction processing request, wherein the at least one transaction processing request comprises the deferred authorization indicator; and
communicating, with at least one processor, the at least one transaction processing request.

10. The method of claim 1, further comprising:
receiving, with at least one processor, at least one transaction processing message for further processing of the deferred authorization transaction, wherein the at least one transaction processing message comprises the at least one transaction processing request;
determining, with at least one processor, whether to authorize or deny the deferred authorization transaction associated with the at least one transaction processing request based at least partially on the transaction processing message;
generating, with at least one processor, a response message comprising an authorization response based on the determining whether to authorize or deny the deferred authorization transaction; and
in response to receiving the at least one transaction processing message, communicating, with at least one processor, the response message.

11. The method of claim 1, wherein the at least one transaction processing request comprises a first message format, the method further comprising:
converting, with at least one processor, the at least one transaction processing request into a second message format, resulting in at least one transaction processing message, based on the first message format, wherein the second message format corresponds to a message format associated with a network, wherein the network is associated with a transaction service provider; and
communicating the transaction processing message having the second message format.

12. The method of claim 1, wherein receiving the at least one transaction processing request comprises receiving the at least one transaction processing request in a first message format, wherein the first message format corresponds to a message format associated with a network, wherein the network is associated with a transaction service provider.

13. A system for processing a deferred authorization transaction, comprising at least one server computer including at least one processor, the at least one server computer programmed or configured to:
receive at least one transaction processing request associated with a transaction, the at least one transaction processing request comprising a deferred authorization indicator, wherein the transaction is initiated using a portable financial device associated with a user;
determine that the at least one transaction processing request comprises the deferred authorization indicator;
determine that the transaction is a deferred authorization transaction based on determining that the at least one transaction processing request comprises the deferred authorization indicator; and
process the transaction using at least one deferred authorization transaction rule in response to determining that the transaction is a deferred authorization transaction.

14. The system of claim 13, wherein the at least one transaction processing request comprises transaction data associated with a chip of the portable financial device.

15. The system of claim 14, wherein the transaction data associated with the chip of the portable financial device comprises an application transaction counter.

16. The system of claim 15, wherein the at least one server computer is further programmed or configured to analyze the application transaction counter of the at least one transaction processing request and authorize or deny the deferred authorization transaction associated with the at least one transaction processing request based at least partially on the application transaction counter.

17. The system of claim 13, wherein the at least one transaction processing request comprises a token associated with an account identifier, wherein the account identifier is associated with the user.

18. The system of claim 17, wherein the at least one server computer is further programmed or configured to retrieve the account identifier based on the token; and
communicate at least one transaction processing message comprising the account identifier.

19. The system of claim 18, wherein the at least one server computer is further programmed or configured to authorize the at least one transaction processing request based at least partially on the account identifier; or deny the at least one transaction processing request based at least partially on the account identifier.

20. The system of claim 13, wherein the at least one server computer is further programmed or configured to communicate at least one transaction processing message for further processing of the deferred authorization transaction, wherein the at least one transaction processing message comprises the at least one transaction processing request.

21. The system of claim 13, wherein the at least one server computer is further programmed or configured to:
receive transaction data associated with the transaction, the transaction data including the deferred authorization indicator;
generate the at least one transaction processing request, wherein the at least one transaction processing request comprises the deferred authorization indicator; and
communicate the at least one transaction processing request.

22. The system of claim 13, wherein the at least one server computer is further programmed or configured to:
receive at least one transaction processing message for further processing of the deferred authorization transaction, wherein the at least one transaction processing message comprises the at least one transaction processing request;
determine whether to authorize or deny the deferred authorization transaction associated with the at least one transaction processing request based at least partially on the transaction processing message;
generate a response message comprising an authorization response based on the determining whether to authorize or deny the deferred authorization transaction; and
in response to receiving the at least one transaction processing message, communicate the response message.

23. The system of claim 13, wherein the transaction processing message comprises a first message format, and wherein the at least one server computer is further programmed or configured to:
convert the at least one transaction processing request into a second message format, resulting in at least one transaction processing message, based on the first message format, wherein the second message format corresponds to a message format associated with a network, wherein the network is associated with a transaction service provider; and
communicate the at least one transaction processing message having the second message format.

24. The system of claim 13, wherein the at least one server computer is further programmed or configured to: receive the at least one transaction processing request in a first message format, wherein the first message format corresponds to a message format associated with a network, wherein the network is associated with a transaction service provider.
